(19) United States
(12) Patent Application Publication
(10) Pub. No.: US 2010/0092905 A1
(43) Pub. Date: Apr. 15, 2010

(54) ORTHODONTIC POWER ARM

(76) Inventor: Laurel R. Martin, Longmont, CO (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 12/249,537

(22) Filed: Oct. 10, 2008

(51) Int. Cl. A61C 7/00

(52) U.S. Cl. 433/18

(57) ABSTRACT

An orthodontic power arm has a body with a bonding surface for attachment to a tooth. A blade-shaped arm extends gingivally from the body and has a width extending in a mesial-distal direction. The power arm is also equipped with a number of recesses in the mesial or distal edges of the arm for engaging a tractive device. For example, the power arm can be made of a clear polymeric material.

### BACKGROUND OF THE INVENTION

1. Field of the Invention

The present invention relates generally to the field of orthodontic appliances. More specifically, the present invention discloses an improved orthodontic device useful for transferring corrective forces to the roots of teeth.

2. Statement of the Problem

In the most fundamental analysis, orthodontic treatment involves the correction of a malocclusion by repositioning teeth to ideal positions and inclinations. One central difficulty involved in repositioning teeth is that it is the roots of the teeth that must be repositioned. The roots are ensconced within an elastic ligament, which in turn is surrounded by malleable bone. As such, the roots are hidden within the living tissues and inaccessible to the clinician. Therefore, the gentle and continuous forces of orthodontic correction must be applied to the roots through the visible and accessible crowns of the teeth.

It can be said then that the practice of orthodontics involves the process of repositioning teeth by translation of the roots through supporting bone. Such repositioning is accomplished by attaching orthodontic forces to the rigid structure of a tooth, using only the crown as the foci. Corrective forces then dissipate into the malleable, supporting bone surrounding the root. When such forces are maintained continuously, a complex physiological response is elicited from the bone. This biological response involves the osteogenetic processes of bone resorption and bone deposition. Orthodontic forces acting on the bone cause bone to be dissolved (resorbed) and carried away on the leading edge, in the direction of movement and conversely, new bone is created on the trailing side. It is the resorption of bone on one side of the root and the creation of new bone (osteogenesis) on the other that drives tooth movement.

On one hand, it is conceptually easy to model the process of tooth movement as being similar to a mechanical system following the laws of conventional Newtonian physics. However, the reader is reminded that orthodontic forces involve a living biological system and that tooth movement should not be modeled as if occurring in a non-living mechanical system. It has been said that for biological systems “form follows function and function follows form”, meaning that biological systems are in a constant process of seeking a structural balance while adapting to external loading and functional forces. The processes of tooth movement are triggered by optimal forces. Subliminal and excessive forces will not necessarily produce desired tooth movement. Only when orthodontic forces are continuous and fall within an optimal range will certain aspects of these biological processes closely mirror mechanical models.

On a simplistic level, a tooth receiving such optimal forces can be visualized as a wooden stick embedded in a box of loose, dry sand. The exposed portion of the stick represents the crown of the tooth. The portion hidden in the sand represents the root portion of the tooth hidden within bone. In this analogy, a mesially- or distally-directed force exerted on the crown of the tooth will tend to move the crown of the tooth in that direction, but it also tips like the stick in the sand about its center of resistance. It should be noted that the center of resistance of the stick makes no relative movement in response to the force. The embedded portion of the stick above the center of resistance does rotate in the direction of the push, but an equal portion of the stick below the center of resistance rotates in the opposite direction of the force. This example represents the problem of undesirable tipping of teeth that orthodontists encounter when a crown is pushed or pulled without a coupled counter-moment.

One common objective in treating an orthodontic case is the bodily translation of teeth. Extraction sites for example require that adjacent teeth be moved either sequentially or en mass to fill an extraction site. Other cases require teeth to be bodily translated for arch development or for the creation of space to alleviate crowding, or for repositioning molars that then serve for anchorage. Other cases may require an entire arch to be repositioned relative to the other arch. In all such cases, the desired orientation of teeth while in transit is upright, (i.e., avoiding rotation and tipping). Tipping sees the crown leading, with the root trailing, like the example of the stick tipping in the sand.

The goal of maintaining roots in parallel relation applies to teeth that are ideally positioned as well as teeth that are being translated. For these reasons, it can be appreciated that the tendency of teeth to tip in response to treatment forces is a central problem within orthodontics. Within these considerations it can be seen that teeth do unfortunately behave like the example of a mechanical system consisting of the stick in the sand. Teeth too have a center of resistance to movement and lacking any coupled counter-moment, they will easily tip, with the crown leading in the direction of the applied force, leaving the root dragging, as shown in FIG. 1. Undesirable tipping occurs around the center of resistance, with the apical tip of the root moving opposite to the direction of the crown movement, as illustrated in FIG. 1a.

The orthodontic armamentarium contains many and varied mechanical approaches to deliver a coupled counter-moment along with lineal corrective forces. These approaches generate a coupled counter-moment to nullify the tendency of teeth to tip. One commonly used anti-tip methodology involves the utilization of Edgewise orthodontic brackets. Orthodontic brackets have an arch slot that engages an archwire. The archwire passes around the entire dental arch. The arch slot, having mesial-distal spaced dimension, engages the archwire to serve as a guide for a tooth to bodily translate along the archwire. The intent of such mechanical constraints is to translate a tooth without tipping. In other words, the archwire serves as a rail, along which the tooth and its attached bracket slide. Elastics in tension, or preferably coil springs in tension provide the motive forces for such movement.

Ideally, the tooth is intended to slide along the archwire without tipping. The archwire, working mechanically with the bracket's arch slot, attempts to maintain the upright posture of the tooth as orthodontic forces push or pull it along the archwire. Again, the objective is to move the tooth while defeating its natural tendency to drag its root. In practice, many difficulties are encountered during such efforts. For example, the anti-tipping characteristics of the coupled bracket-archwire system described above perform best when a high modulus, full-sized archwire is in place in the mouth. Such wires have the structural integrity to serve as the rigid rail described above. Unfortunately, such rigid, full-sized wires are typically used later during the final finishing stage of treatment. To further confound these difficulties, bodily translation for space closure and arch development are goals that are typically undertaken during earlier stages of treatment. Such steps typically coincide with treatment phases where much more flexible, low-rate archwires are in place. Such low spring-rate temper archwires do not have the rigidity to serve as a rail and cannot produce an optimal anti-tip couple within the mesial-distal width of an orthodontic bracket.

Even in the rare situation where bodily movement is attempted while a rigid, high-modulus archwire is in place, considerable binding and friction can occur between the archwire and the bracket, which is another factor that can halt tooth movement altogether. For example, in response to the treatment force, the tooth can begin to tip, with the apical tip of the root rotating about the center of resistance, as shown in FIGS. 1 and 1a. The bracket, being rigidly attached to the tooth reacts by loading the archwire, causing the archwire to deflect into a zigzag configuration as it attempts to create a counter-moment offsetting the tendency of the tooth to tip, as illustrated in FIG. 1. These zigzag bends in the archwire are obstacles that result in friction and binding, and can markedly slow or stop translation of the tooth along the archwire. Eventually the system of forces will stabilize, and the function of the archwire may serve to only reduce tipping. The point here is that the forces generated between the archwire and the arch slot at the points where the archwire enters and exits the slot can be exceedingly high. This concentration of forces within the zigzag configuration of the archwire can markedly slow or stop needed bodily translation of a tooth altogether.

Considerations of sliding friction, hysteresis and binding between the archwire and bracket system are referred to by orthodontists as “sliding mechanics.” The problem of friction between the archwire and the arch slot has long been recognized as a constraint, and much innovation has been directed toward the considerations of sliding mechanics and means for reducing friction. U.S. Pat. No. 5,470,228 to Franseen et al. and U.S. Pat. No. 5,160,261 to Peterson both describe improvements that reduce the binding and friction between an orthodontic bracket and its archwire.

Likewise, the central tendency of teeth to tip in response to treatment forces has been the focus of research and advancement. For example, U.S. Pat. No. 4,975,052 to Drs. Haskell and Spencer discloses a cuspid-retraction spring intended to distally translate a cuspid into an edentulous space created by the extraction of a first bicuspid tooth. The retraction spring disclosed by Haskell and Spencer is configured through the use of finite element analysis, a computer-based force-modeling tool, to create an exact counter-moment to the tipping. Once the retraction spring is cinched-in and in tension, the vector resultant pulls the cuspid distally and upright. The counter-moment is effectively transferred to the region of the center of resistance, thereby allowing the cuspid to bodily move distally while maintaining an upright posture.

Another approach to this problem has been to incorporate occlusal arms into orthodontic appliances. During the fabrication of orthodontic appliances within the orthodontic support laboratories, an occlusal arm passing across the occlusal surface of a molar may be installed, for example. Such arms (sometimes called “occlusal rests”) extend across to the occlusal aspect of an adjacent tooth. Such a feature is intended to counter a tipping moment that can result from other forces generated within the appliance.

In addition, many orthodontists install various types of biasing bends in archwires or segmental springs which provide an anti-tipping bias in anticipation of an undesirable tipping Brackets can be bonded to teeth in ways that somewhat bias a tooth against an anticipated tendency to tip. Orthodontists employ such anti-tipping biasing methods routinely in response to anticipated tipping or actual tipping when it occurs.

As can be appreciated from the foregoing, the fact that orthodontists are relegated to applying corrective forces only to the crowns of teeth, when in fact it is the roots of the teeth that are the functional recipients of such forces causes a myriad of undesirable reciprocal force vectors. Such vectors tend to impart unwanted rotational or tipping vectors to the teeth and as such, such unwanted tooth movements pose numerous additional challenges to the delivery of treatment.

Another improvement to the orthodontic armamentarium directed toward anti-tipping was developed in the late 1980s. Special brackets were introduced exhibiting long arms extending gingivally. The arms were configured with an elastic hook at their terminus. Such arms, called “power arms”, were sufficiently long so that they extended alongside the soft tissues to the general level of the center of resistance of the tooth and thereby allowed tractive forces to be applied at, or very near to the center of resistance. These power arm brackets exhibited a tendency for the long hook/arm to bend, sometimes into the soft tissues of the gum or cheeks. Other undesirable attributes of metallic bracket-borne power arms involved aesthetics, and the undesirable metallic appearance they presented. As a result of this, along with high breakage rates and other problems, these brackets did not become popular with orthodontists. Nonetheless, such a design, in conjunction with the “rail” effect of the archwire avoided the binding of the archwire. Such brackets were effective in their fundamental role of translating teeth with greatly reduced tipping because the forces were directed to the center of resistance.

Today, the standard practice of orthodontics involves options for new treatment modalities such as aligner-based treatment. An outgrowth of tooth positioners first developed in the late 1940's, aligner-based therapy has become popular with orthodontists and patients alike. U.S. Pat. No. 5,975,893, which issued in 1999 assigned to Align Technologies teaches methods for making aligners. Many continuations and subsequent patents assigned to Align Technologies provide an in-depth description of the methodologies of aligner-based therapy.

In this method of treatment, thin pressure-formed transparent polymeric shells are fashioned to precisely fit over the teeth of an arch. Each tooth-receiving compartment however is formed to be slightly out of position and biased in the direction of desired tooth movement. Through the wearing of many such progressively-biased appliances, the teeth are gradually urged into their final, desired positions. Aligner-based therapy has been proven effective and is especially popular with patients because the metallic-look of conventional braces is avoided. Aligner-based therapy is an alternative to conventional treatment and as such, aligner-based therapy does not typically employ brackets or archwires. Aligner-based treatment is intended to be a treatment modality that requires using no metallic components whatsoever.

The present invention is intended primarily for use with aligners and as an adjunct to aligner-based orthodontic treatment. The present invention serves to ameliorate some of the inherent shortcomings of aligners as well as enhance their existing capabilities To appreciate the functioning of the present invention, first a more detailed description of aligners follows:

Aligner-based therapy begins with the use of one of several available methods for creating a virtual model of the patient's occlusion. The virtual model will reside within computer-aided design (CAD) software on a digital computer. This first step can begin with the taking of a standard orthodontic impression of the patient's teeth. The impression may be subjected directly to a CT scanning process or stone positive models of the teeth can be poured from the impressions and laser scanned. Other means exist for transferring the dental realities of the patient to the virtual CAD environment including the step of directly scanning the teeth using an inter-oral wand containing a triplet of micro video cameras.

Within the virtual CAD environment, the patient's dentition is manipulated in various ways. The progressive aligner fabrication process is complex, but in essence, the case is virtually treated by a CAD technician resulting in the patient's original malocclusion being virtually corrected, as prescribed and directed by the attending orthodontist with each of the teeth moved into desired finished positions. The interdigitation of the two arches is accommodated. The final result represents the dental realities that would result at the end of the active phase of traditional orthodontic treatment, which would typically require one to three years.

At that stage then, two virtual models reside within the CAD software. One model represents the pre-treatment original malocclusion and the other model represents the finished occlusion objective. Even though simplified, it will suffice to say that the sequence between the beginning and the finished models can be converted to a sequential series of virtual CAD models. Each individual CAD model of the series depicts all of the teeth in slightly better positions than the previous model. Each model may represent about two weeks of tooth movement. As many as forty or more progressive CAD models may be required to take the case completely from start to finish. Extreme cases can involve up to seventy five sets.

In the process being described, each of the forty (for example) virtual models of the teeth is represented by a CAD file. Each of those CAD files is directed to a rapid prototyping machine where a physical model of the occlusion is precisely duplicated. The physical models then serve for yet another process where thin (typically 0.035 inch thick) clear polymeric material is formed over the physical model. The forming process involves heat and pressure and can be considered a version of thermo-forming. In this manner, sets of upper and lower progressive aligners are created. After trimming and numbering, the aligners produced in this sequence are considered ready for delivery to the orthodontist, who then delivers them to the patient.

The process results in a polymeric shell that is defined by a series of tooth-receiving compartments where each compartment is sized and shaped to intimately accept its corresponding tooth. The aligner exactly duplicates the dentition and will fit over all of the teeth of the patient's dental arches. The reader is reminded however that as described earlier, each of the tooth-receiving compartments of the aligner is positionally biased to urge the teeth into new positions.

Progressive aligners have proven to be effective in many treatment modes, but for certain teeth, some types of correction are difficult to accomplish with aligners. To illustrate this, consider the blade-shaped anterior teeth, which are characterized by a single incisal edge. Due to that morphological shape, aligners can impart corrective forces in terms of rotation, angulation and torque because the shape provides a good mechanical handle for the rigid, yet moderately flexible aligner. The blade shape of the anterior teeth allows the aligner to grasp the tooth mechanically and thus corrective forces can be efficiently transferred to the roots of those teeth. The conical-shape of cuspid teeth poses a much more difficult shape for aligners to grip. Being essentially cone-shaped, the application of force by an aligner tends to unseat and lift the aligner. To counter this problem, the aligner-based methodology provides various wedge-shaped devices, which are bonded to the cuspids for example that serve as retentive handles, to allow an aligner to achieve a better grasp a tooth. Bicuspid teeth may be considered as posing an intermediate problem in that they do have distinct gripping features but at the same time, they are conically tapered like cuspid teeth when viewed in plan-form from their mesial or distal aspects. Certain corrective forces such as torque may be difficult to impart to bicuspids using aligners.

As can be appreciated from the previous description of aligners and aligner-based therapy, just as is the case with other modes of treatment, aligners have their strong points and their weak points. Regarding the weak points in particular, one involves the fact that orthodontists frequently need to bodily move teeth, as covered earlier. Aligners are poorly suited for gripping a crown in a sufficiently rigid manner to prevent the tooth from dragging its root during translation. This is particularly true for conically-shaped teeth.

3. Solution To The Problem

The present invention addresses this issue and others as described below by using a blade-shaped power arm that can be made of a polymeric material and is suitable for use in aligner-based treatment. The blade shape allows the power arm to be sufficiently long to provide an attachment point for a tractive force near the center of resistance of the tooth, yet structurally rigid in the plane of tractive forces exerted by a tractive device attached to the power arm. The present invention also offers a number of other advantages, as described below.

First, the present invention can be molded from clear or translucent biocompatible plastics. Transparent plastics can be utilized in order to maintain and complement the very desirable aesthetic properties of aligners.

Tthe present invention is well suited to prevent the tendency of teeth to tip while moving, by providing an attachment point for a tractive device that is near the center of resistance of a tooth. There is a compelling synergy of these attributes predicting that the present invention will significantly augment aligner-based therapy.

Furthermore, since the power arm can be made of a polymeric material, no steel bracket portion is required to attach the present invention to a tooth. The bracket-based metallic power arms of the past are generally incompatible with aligners because the bracket would interfere with the seating of an aligner on the teeth.

Finally, the incorporation of temporary anchorage devices (TADs) into aligner-based therapy has great potential, but attachment of forces between individual teeth and aligners is sometimes awkward and not durable in the mouth. The use of the present invention along with aligners and TADs in combination presents essentially a completed system with great overall capability. The physical geometry of the present invention, with attachment points well into the vestibule matches well with the typical location for the placement of TADs.

### SUMMARY OF THE INVENTION

This invention provides an orthodontic power arm having a body with a bonding surface for attachment to a tooth. A blade-shaped arm extends gingivally from the body and has a width extending in a mesial-distal direction. The power arm is also equipped with a number of recesses in the mesial or distal edges of the arm for engaging a tractive device. For example, the power arm can be made of a clear polymeric material.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is an elevational view of the facial surface of the crown of a tooth 20 being tipped by conventional orthodontic treatment using a bracket 27 and archwire 28.

FIG. 1a is an elevational view of showing rotation of a tooth 20 about its center of rotation between an initial position and a tipped position.

FIG. 2 is a front (or buccal) perspective view of a power arm 10 embodying the present invention.

FIG. 3 is a rear (or lingual) perspective view of the power arm 10.

FIG. 4 is a front (or buccal) view of the power arm 10.

FIG. 5 is a right side elevational view of the power arm 10.

FIG. 6 is a rear (or lingual) view of the power arm 10.

FIG. 7 is a left side elevational view of the power arm 10

FIG. 8 is a top (or occlusal) view of the power arm 10.

FIG. 9 is a bottom (or gingival) view of the power arm 10.

FIG. 10 is a lateral view of a portion of a patient's dental anatomy showing a power arm 10 bonded to a tooth 20, with an elastic 40 extending between the power arm 10 and a TAD 50.

FIG. 11 is a cross-sectional view of a portion of a patient's dental anatomy showing a power arm 10 that has been shaped to follow the contours of the tooth and gingival tissue.

FIG. 12 is a lateral view of a portion of the patient's dental anatomy showing an aligner 30 seated over teeth with a power arm 10 attached.

FIG. 13 is an elevational view of the facial surface of the crown of a tooth 20 with a power arm 10 attached showing the alignment of the tooth's centroid 22 with one of the notches 16 in the power arm 10.

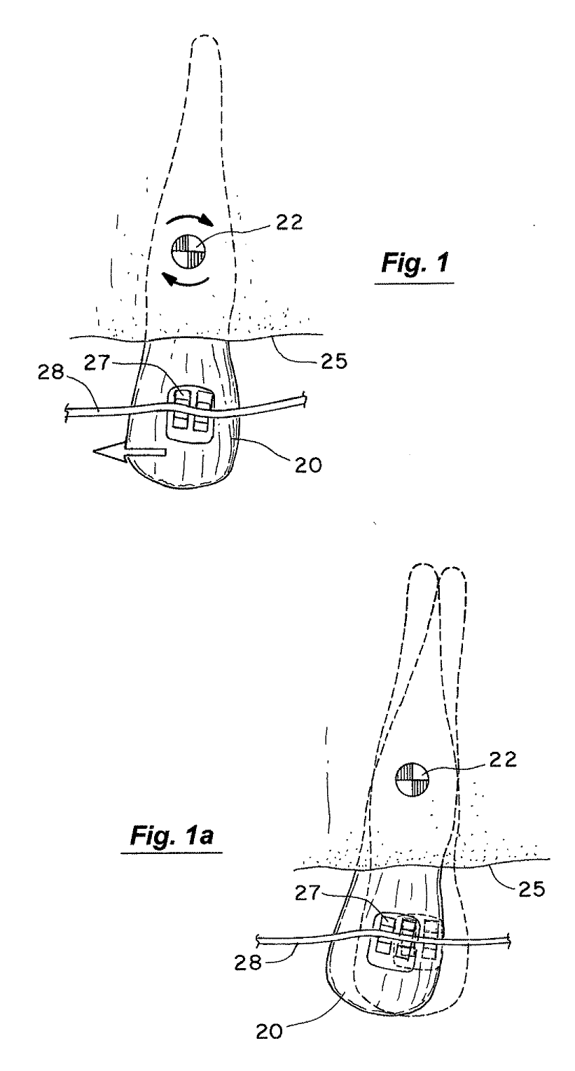

### DETAILED DESCRIPTION OF THE INVENTION

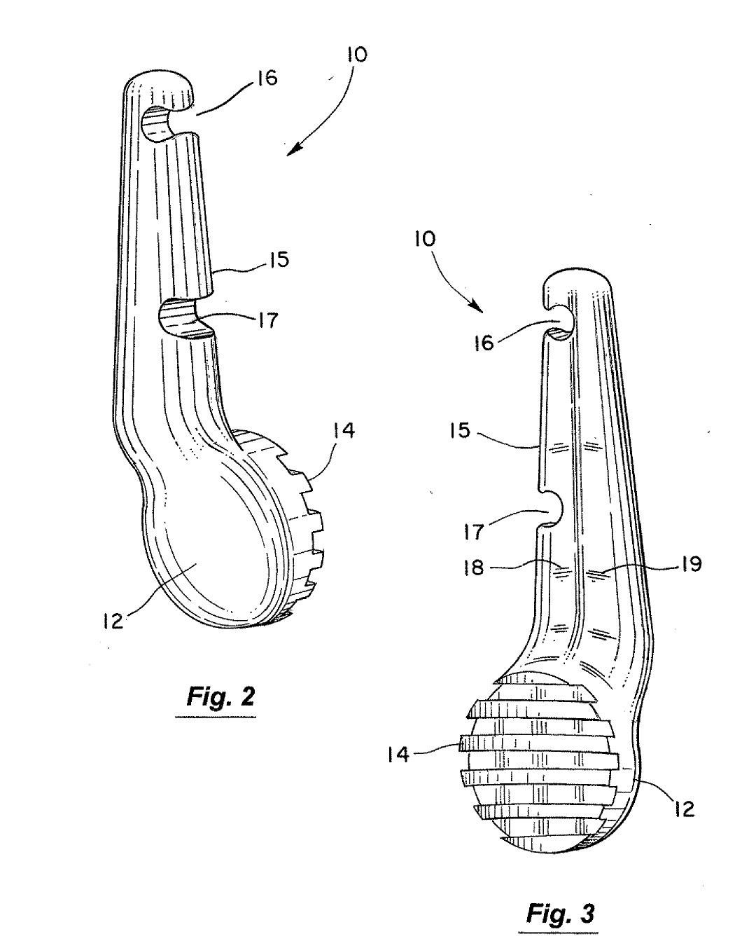

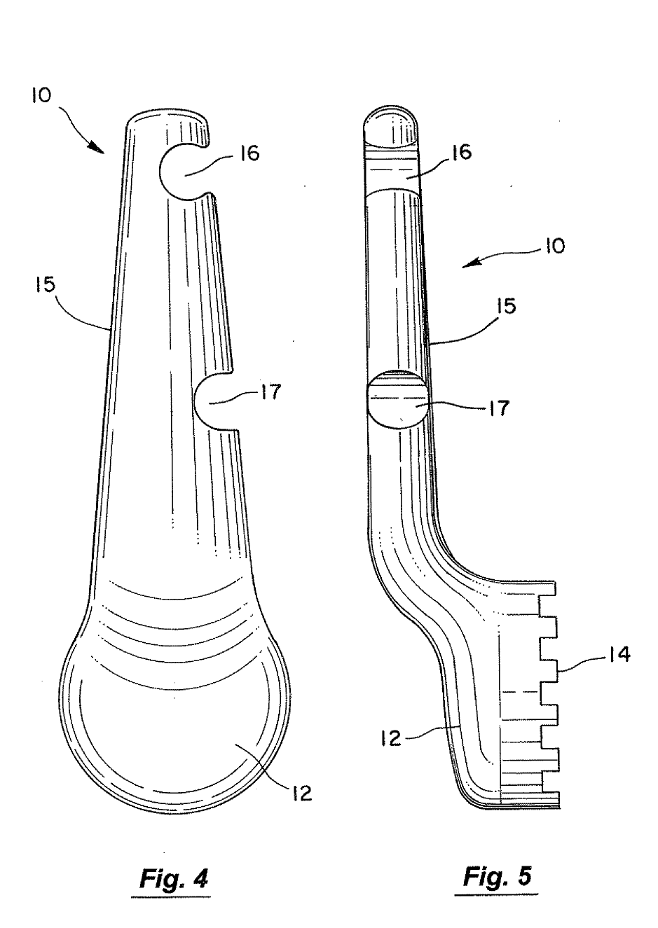

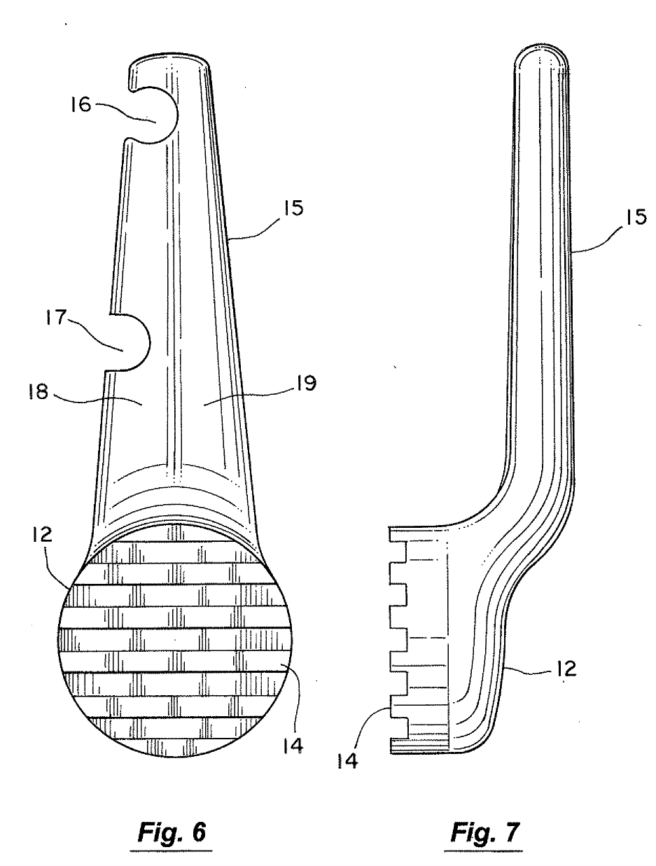

Turning to FIG. 2, a front perspective view is shown of a power arm 10 embodying the present invention. FIG. 3 is a corresponding rear perspective view. Corresponding front, side, rear, top and bottom views of this power arm 10 are provided in FIGS. 4-9, respectively. The power arm includes a body 12 for attachment to a tooth 20. In this embodiment, the body 12 is substantially button shaped and has an uneven bonding surface 14 that is anatomically contoured with increased surface area to facilitate bonding the power arm 10 to a tooth 20 using an adhesive. For example, this uneven bonding surface 14 can have a series of parallel ridges contoured to follow the typical surface of a tooth, as shown in the accompanying drawings, or a checkerboard pattern of raised squares to increase the surface area for bonding.

A blade-shaped arm 15 extends gingivally from the body 12 of the power arm 10, preferably to a region slightly beyond the center of resistance of a typical tooth. The body 12 also provides a labial outset for the arm 15. The arm 15 has a significant width in the mesial-distal direction, but a relatively small thickness in the lingual-labial or lingual-buccal direction. As shown in the side views depicted in FIGS. 5 and 7, the arm 15 also curves labially outward from the body 12. Beyond this initial outward labial curvature, the arm can either be substantially straight (as shown in FIGS. 2-9), or it can be contoured to follow the profile of the tooth and gingiva (as shown in FIG. 11). As discussed below, the power arm 10 can be made of a polymeric material that allows the arm 15 to be custom shaped during manufacture or custom formed by the orthodontist to meet the needs of a specific patient's dental anatomy.

The edges of the arm 15 are defined by the mesial-distal extent of the arm. The thickness of the arm 15 can be tapered toward these edges so that these edges are thinner than the central portion of the arm 15. The arm 15 can also be tapered in the gingival direction, as shown in the drawings.

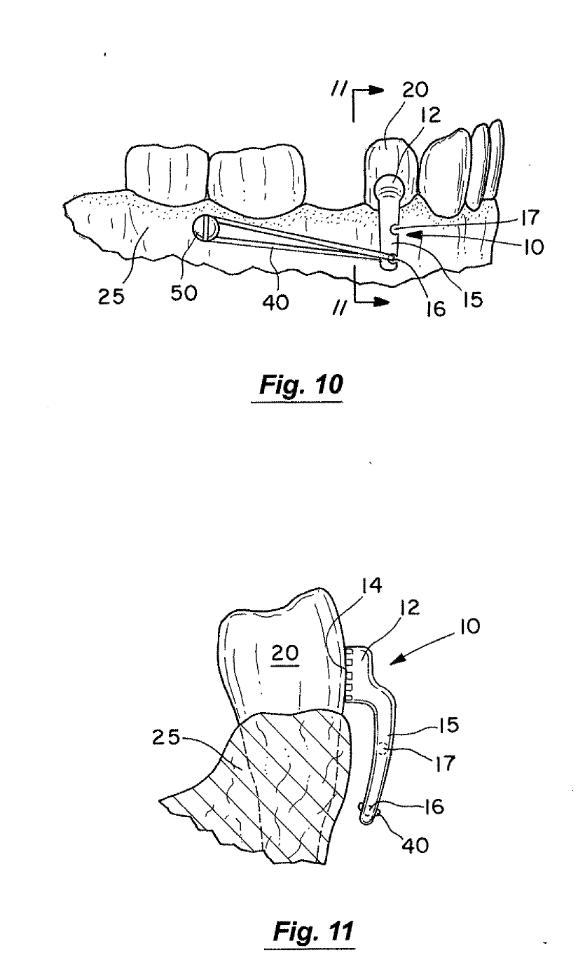

A number of recesses or notches 16, 17 are formed in at least one of the edges of the arm 15. These recesses 16, 17 are intended to engage an elastic 40 or other tractive device (e.g., Ni—Ti retraction spring assemblies, energy chains, or urethane elastomeric threads) to the power arm 10. For example, FIG. 10 is a lateral view showing an elastic 40 extending between a recess 16 on a power arm 10 and a TAD 50. Preferably, at least one of the recesses 16 is at or near the elevation of the center or resistance 22 of the tooth 20, as illustrated in FIG. 13. The recesses can have any of the variety of shapes or configurations. The recesses 16, 17 shown in the drawings are substantially C-shaped. The apertures of the recesses 16, 17 can be sized to retain a tractive device in the event the other end of the tractive device becomes released from its point of attachment. This helps to prevent the tractive device from being accidentally swallowed by the patient. Alternatively, the recesses 16, 17 could be U-shaped or V-shaped. A recess could also be formed by creating a bend or corner in the arm 15 itself. For example, the arm 15 could have a T-shape, S-shape, C-shape or an inverted L-shape or J-shape, so that the resulting corners or bends serve as recesses to engage a tractive device.

The embodiment of the arm 15 shown in the drawings is generally left-right symmetrical about its vertical axis, with the exception of the recesses 16, 17. This simplifies manufacture in that a single mold can be used to produce blanks that can finished into both right- and left-handed versions of the completed power arm by machining suitable recesses. Alternatively, separate molds could be used to produce right- and left-handed versions of the power arms. It should be understood that asymmetrical embodiments could be readily substituted. In fact, asymmetrical power arms may have superior structural properties in handling the forces exerted by a tractive device.

The power arm 10 can be made of a variety of materials. Preferably, the power arm 10 is molded from a biocompatible polymeric material. This allows the final product to be substantially transparent or translucent, or have any desired color. Alternatively, it could be machined or cast from metal, ceramic, plastic or composite materials.

As previously mentioned, the present invention is particularly advantageous in aligner-based treatment. One factor that has made aligners popular with patients is termed “aesthetics”. The stereotypical patient for aligner-based therapy is a young professional person who perhaps needed, but did not receive orthodontic treatment in their early teens. Aligners can be removed if desired, but even when in place, they are essentially invisible, which is ideal for people whose appearance is important. For these people, aligner-based therapy provides an option to the metallic appearance of conventional steel braces, which would be unacceptable. The present invention can be molded from clear or translucent biocompatible plastic and therefore does not present a significant reduction in the aesthetics of aligners. As such, the present invention, if compared to the bracket-borne metallic power arms of the past, is far less noticeable.

As described earlier, aligners are usually thermoformed from relatively thin sections of clear polymeric sheet material. During forming, the formed surfaces tend to thin out and are therefore are thinner than the original material from which it was formed. Still, the typical thickness of a tooth-receiving aligner compartment may range from 0.018 to 0.030 in. Due to that thickness, any attachment on the surface of a crown should have features that are correspondingly outset further away from the enamel by the thickness dimension of the aligner. Without such outsetting, the functioning or accessibility of any attachment can be compromised when used simultaneously with an aligner. The present invention addresses this problem by increasing the thickness of the body 12 of the power arm 10 in the labial-lingual or buccal-lingual dimension to adequately outset the arm 15 from an aligner 30. Such outsetting of the arm 15 serves to accommodate the added thickness of an aligner, and thus maintains the accessibility of the arm 15 so that the body 12 adequately clears the outer surface of the aligner 30. Such outsetting also plays a role in establishing adequate distance between the soft tissues and the arm to prevent food from becoming packed in between. Such outsetting further provides access and clearance for installing tractive devices.

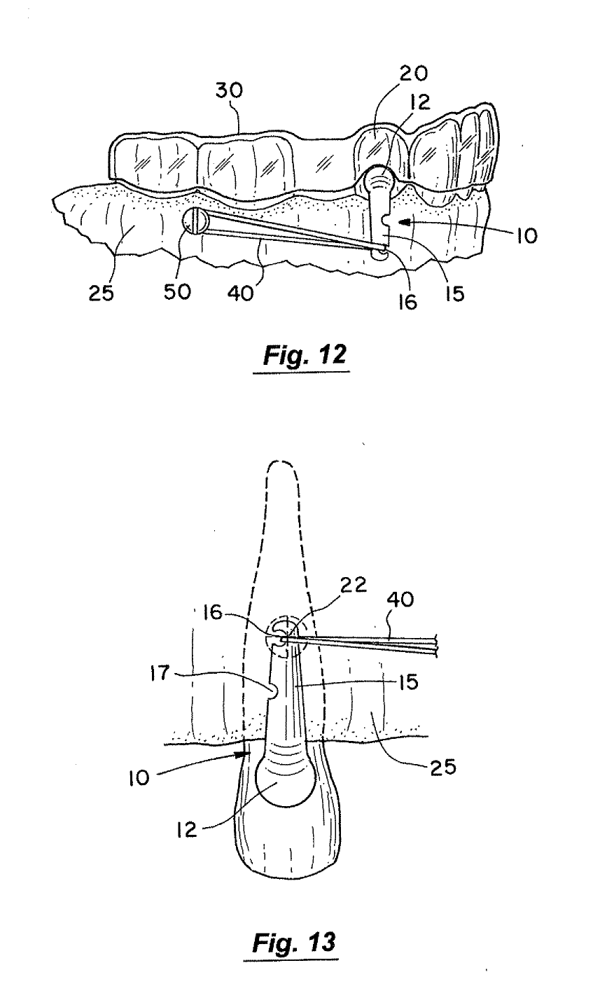

Since the power arm can be bonded more gingivally than the sighting position of a conventional bracket, for example, only a slight relief is needed along the gingival edge of an aligner, allowing the aligner to be seated without interference with the power arm. For example, FIG. 12 shows an aligner 30 seated over teeth with a power arm 10 attached. If needed, a cutout can be formed in the edge of the aligner 30 to accommodate the body 12 of the power arm 10.

The present invention also has the advantage of offering multiple points for attachment of forces to the power arm. Statistically, a normal upper cuspid tooth may be about 28 mm long when measured from its occlusal point to the apical tip of its root. An upper first bicuspid however may only measure 21 mm. As can be appreciated, the occlusal-gingival location of the centers of resistance in these two examples will correspondingly be located at two different depths in the supporting bone. In order to apply forces as close to the center of resistance as possible to teeth of naturally varying lengths, the present invention can provide multiple points for attaching tractive devices, such as elastics. For example, the accompanying drawings show an embodiment of the present invention having a first recess 17 in the mesial or distal edge of the arm that is located about 4 mm from the center of the bonding surface, and a second recess 16 located about 7 mm from the center of the bonding surface. The presence of multiple attachment points provides practitioners with a number of options. For example, the availability of multiple attachment points allows a modulation of the tractive force between more bodily movement and less of an anti-tipping moment, or less bodily movement and more of an anti-tipping moment. This can be regulated according to actual observed response of the tooth to corrective forces during the course of treatment. Primarily however, the choice of attachment point will be governed by the length of the subject tooth or desired movement.

Another useful aspect of the present invention is that should the 4 mm point be used, the unused portion of the arm may be removed by grinding or cutting. Removing the unused portion of the polymeric power arm may be desirable from a patient comfort standpoint or for hygienic reasons. Such an approach also permits the orthodontist to use the longer (7 mm) point first, and later the 4 mm point may be used, and the length of the arm can then be reduced.

Metallic brackets depend on a mechanical interlock-type bond to become securely attached to the enamel. The present invention however, being formed from a polymeric material, can join in the bonding process by chemically interacting to the orthodontic adhesive system. As such, the polymeric power arm, also having features that increase the area of its bonding surface, can also accommodate mechanical interlock adhesion, resulting in an overall increase in bond strength provided by both mechanical and chemical bonding.

The present invention also has an arm 15 that can be contoured to the profile of the gingiva and gum 25, as shown in FIG. 11. Unlike orthodontic brackets that are generally bonded in the center of the facial surface of a crown, the present invention is intended to be located within about a millimeter of the gingival margin. Because of that, the profile of the present invention, as viewed from its mesial or distal aspect can be formed to take a pronounced outward step to clear the soft tissue. Gingival margins can become slightly irritated, and puffy during orthodontic treatment, so clearing the soft tissue by incorporating an out-stepped profile is another important aspect of the present invention.

The gum tapers away from the gingival margin of some teeth differently than others. For example, the soft tissues above an upper bicuspid continue to widen at points further upward into the vestibule. The soft tissue below a lower cuspid curve lingually or inward somewhat, forming a sort of concave shape extending down into the lower vestibule, as shown for example in FIG. 11. As depicted in this figure, the arm 15 is shown first stepping out away from the soft tissue to pass with at least 0.75 mm clearance over the gingival margin. As it continues extending downward, the arm follows the typical bulge then the concave curvatures of the lower gum. The present invention is intended to follow the general morphology of the soft tissue in this manner, maintaining a minimum clearance from the soft tissue. Such compliance with the contour of the soft tissues avoids the potential for patient discomfort and irritation of the cheeks that could occur if the arm 15 extends too prominently outward. Conversely, if the arm 15 passes too closely to the soft gum 25, a trap can be formed where food can become trapped between the arm 15 and the soft tissues during mastication.

The present invention is also advantageous for use with aligners and temporary anchorage devices (TADs) in combination. For example, FIG. 10 shows an elastic 40 extending between a power arm 10 and a TAD 50. As noted earlier, metallic power arms incorporated into the structure of special brackets were used by orthodontists in the late 1980s, but due to breakage and other problems, they did not endure as a commercial success. Popular use of aligners and aligner-based therapy is a new development that began seeing wide acceptance in recent years. An equally important and even more recent development is the rapid acceptance within the orthodontic profession of temporary anchorage devices (TADs). Such devices are essentially small-diameter self-tapping screws molded and sintered from titanium feedstock. TADs are designed to be threaded or screwed directly into the hard cortical bone of the mandible or maxilla. TADs are often installed by oral surgeons as directed by the orthodontist, but orthodontists and dentists are increasingly inserting TADs themselves.

Traditionally, in delivering corrective forces to reposition teeth, orthodontists have unavoidably generated reciprocal forces of anchorage that were dissipated within the living structures. All too often, traditional armamentarium directed those reciprocal forces to other teeth or groups of teeth and as such, the orthodontist was forced to manage treatment-induced orthodontic problem as those anchor teeth also moved in response. Today, the use of the TADs provides anchor points for orthodontic forces that have essentially zero reciprocal effect. Being inserted into the hard bone, reciprocal orthodontic forces become grounded and trigger no undesirable tooth movement.

Care is required in placing TADs. TADs must be inserted at points where the threaded portion will pass clear of the roots of teeth. The threaded portion engages the harder cortical bone that surrounds the softer alveolar bone. When installed between roots of two teeth, the location must be adequately well down between the tapered roots so as to not interfere with the periodontal ligament of either adjacent tooth. TADs must be inserted anticipatorily in regions of bone where treatment will not require roots to subsequently pass through. Given these placement limitations and guidelines, TADs are usually inserted through the soft tissue and into the hard bone at levels roughly coincident with the centers of resistance of teeth. As such, in the occlusal-gingival axis, TADs happen to fall at the same general elevational level as the recesses 16, 17 of the power arm 10, as shown for example in FIG. 10. These factors work together well since having the recesses 16 and 17, the centers of resistance of the teeth, and the TAD falling at generally the same occlusal-gingival level helps avoid unwanted vertical components to the mesial- or distally-directed tractive vectors. Should a vertical component be indicated, one or more of these three elements can be adjusted higher or lower.

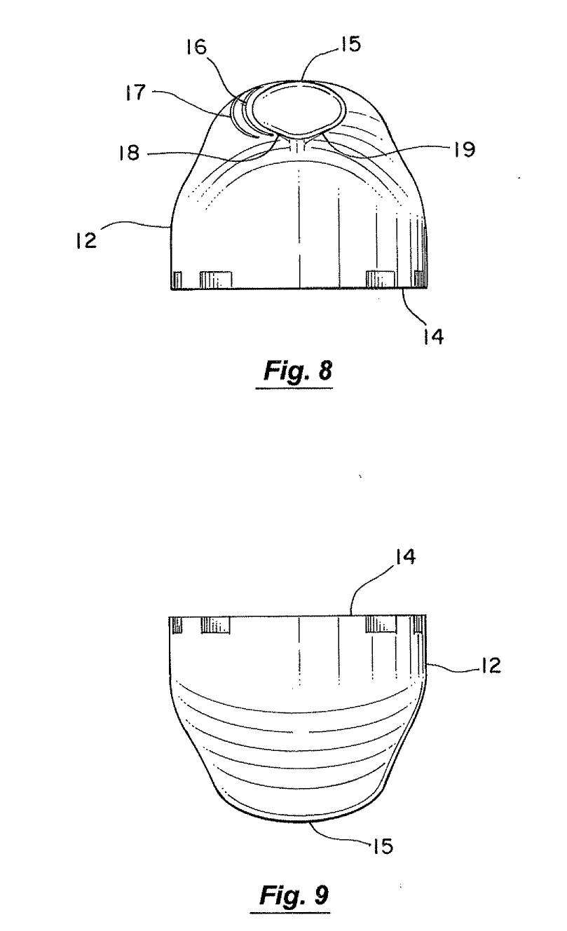

Finally, the present invention includes additional features serving to reduce the tendency for food to become compressed between it and the gum. The problem of a food trap has been referenced above. In addition to the configuration of the arm being contoured to follow the natural curvature of the soft tissue, the lingual side of the arm can be faceted, with the two facets 18 and 19 forming an obtuse angle of about 150 degrees, as shown in FIGS. 3 and 8. The flats 18, 19 contribute to food being naturally flushed from between the lingual side of the arm 15 and the soft tissue. The two flat surfaces 18 and 19 oriented at such a shallow angle also reduce the tendency for food to become compressed in between the power arm 10 and the soft tissue.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. An orthodontic power arm comprising:
a body for attachment to a tooth;
a blade-shaped arm extending gingivally from the body and having a width extending in a mesial-distal direction with opposing edges; and
at least one recess in an edge of the arm for engaging a tractive device.

2. The orthodontic power arm of claim 1 wherein the body further comprises an uneven bonding surface for bonding attachment to a tooth.

3. The orthodontic power arm of claim 1 wherein the recess has an aperture sized to retain a tractive device.

4. The orthodontic power arm of claim 1 wherein the recess is at the elevation of the center of resistance of the tooth.

5. The orthodontic power arm of claim 1 wherein the arm curves labially outward from the body to follow the contours of the tooth and gingival tissue.

6. The orthodontic power arm of claim 1 wherein the thickness of the arm is tapered toward the edges.

7. The orthodontic power arm of claim 1 wherein the orthodontic power arm is made of plastic.

8. The orthodontic power arm of claim 7 wherein the orthodontic power arm is transparent.

9. The orthodontic power arm of claim 1 further comprising a plurality of recesses spaced along at least one edge of the arm.

10. The orthodontic power arm of claim 1 wherein the body is substantially button-shaped and provides a labial outset for the arm.

11. An orthodontic power arm comprising:
a body having an uneven surface for bonding attachment to a tooth;
a blade-shaped arm extending gingivally from the body and having a width extending in a mesial-distal direction with opposing edges, wherein said arm curves labially outward from the body to follow the contours of the tooth and gingival tissue; and
at least one recess in an edge of the arm for engaging a tractive device.

12. The orthodontic power arm of claim 11 further comprising a plurality of recesses spaced along at least one edge of the arm.

13. The orthodontic power arm of claim 11 wherein the thickness of the arm is tapered toward the edges.

14. The orthodontic power arm of claim 11 wherein the orthodontic power arm is made of plastic.

15. The orthodontic power arm of claim 14 wherein the orthodontic power arm is transparent.

16. The orthodontic power arm of claim 11 wherein the body is substantially button-shaped and provides a labial outset for the arm.

17. An orthodontic power arm comprising:
a body for attachment to a tooth;
a blade-shaped arm extending gingivally from the body and having a width extending in a mesial-distal direction with opposing edges, with the thickness of the arm being tapered toward the edges; and
at least one recess in an edge of the arm for engaging a tractive device.

18. The orthodontic power arm of claim 17 wherein the body further comprises an uneven surface for bonding attachment to a tooth.

19. The orthodontic power arm of claim 17 wherein the body is substantially button-shaped.

20. The orthodontic power arm of claim 17 wherein the arm curves labially outward from the body to follow the contours of the tooth and gingival tissue.
